(19) United States
(12) Patent Application Publication
(10) Pub. No.: US 2017/0139945 A1
(43) Pub. Date: May 18, 2017

(54) APPARATUS AND METHOD FOR DECIMATION OF HISTORICAL REFERENCE DATASET

(71) Applicant: GENERAL ELECTRIC COMPANY, Schenectady, NY (US)

(72) Inventors: Devang Jagdish Gandhi, Lisle, IL (US); Travis Hickey, Lisle, IL (US); Chad B. Gooch, Lisle, IL (US)

(21) Appl. No.: 15/322,810

(22) PCT Filed: Apr. 20, 2015
(86) PCT No.: PCT/US2015/026632

§ 371 Date: Dec. 29, 2016

Related U.S. Application Data
(60) Provisional application No. 62/020,699, filed on Jul. 3, 2014.

(51) Int. Cl. G06F 17/30

(52) U.S. Cl. CPC G06F 17/30144

(57) ABSTRACT

Approaches are provided where a group of historical data respresenting a model are obtained which include plurality of vectors which in turn include a group of sensor data values. At least one boundary condition is determined for the historical data, and the boundary condition is preserved. The filtered group of historical data is down-sampled and the model is rebuilt using the down-sampled historical data.

### BACKGROUND OF THE INVENTION

Field of the Invention

The subject matter disclosed herein generally relates to reducing the size of data sets.

Brief Description of the Related Art

In industrial control operations or models, equipment is monitored to ensure proper operation and/or detect anomalies which may arise. The monitoring devices may include any number of sensors which obtain and/or measure data points of the equipment. This sensor data is then used in cooperation with computing components that analyze the data for various purposes such as to provide operational or repair guidance. Accordingly, computational devices must store and preserve this data should further inspection be required at a later date.

Oftentimes, large amounts of unused data are stored as a part of this historical data. However, only a small fraction of this data may be desired. This desirable data may be used as reference data, of which an even smaller fraction may be required for properly modeling a desired control operation or system. This historical data may also serve the purpose of providing a historical context to end users to enhance their interaction with the control system and increase their confidence in the performance of their model.

Having a large amount of data may negatively impact product performance. For example, it may take an unreasonably long time to generate computations and/or models due to the size of the computed data, which may result in system downtime and inefficiencies. Further, it may be costly to store and maintain storage components in addition to maintaining the necessary networking systems capable of transmitting large amounts of data in an efficient manner. Previous attempts to reduce the size of historical data oftentimes result in relevant contextual information being destroyed or eliminated.

The above-mentioned problems have resulted in some user dissatisfaction with previous approaches. Accordingly, it is desired to reduce the size of the historical data while preserving relevant contextual information.

### BRIEF DESCRIPTION OF THE INVENTION

The approaches described herein provide systems and related methods that allow for the size of historical data to be reduced to provide for reduced empirical model run times as well as analytics provided to system operators. These approaches also preserve relevant contextual information, thus the empirical model may accurately function based on this historical data.

As an example, these approaches may allow historical data to be down sampled by at least one order of magnitude. A user may determine their desired target size, and unnecessary data may automatically be removed.

In some forms, the data set may have an unusual distribution that cannot easily be quantified. It may be desirable to preserve data close to the concentrated portions of the distribution while ignoring other data. To capture the unusual distribution, repeated statistical median values may be obtained to arrive at data points which are closer to the concentrated region. By oversampling this area, relevant data are retained.

In some approaches, an apparatus for down sampling historical data representing a model is provided which includes an interface having an input and an output and a control circuit coupled thereto. The control circuit is configured to obtain, via the input, a group of historical data representing a model comprising a plurality of vectors, which in turn include a group of sensor data values. The control circuit then applies a filter to a group of historical data and determines at least one boundary condition for the group of historical data.

The control circuit is further configured to preserve the at least one boundary condition and down-sample the filtered group of historical data without down-sampling the at least one boundary condition. The control circuit then rebuilds the model using the down-sampled historical data.

In some approaches, down-sampling the filtered group of historical data includes computing a plurality of magnitudes of the plurality of vectors and using a statistical sampling of the plurality of magnitudes to obtain a reduced distribution of the group of historical data to transmit via the output.

In some forms, the control circuit may be configured to arrange the vectors in a particular arranged distribution. The statistical sampling of this arranged distribution may be used to obtain the reduced distribution of the group of historical data. In some of these examples, the statistical sampling of the arranged distribution may include a plurality of median values used to obtain a subset of the arranged distribution. The control circuit may compute a plurality of subsequent statistical medians of a subset of the arranged distribution to obtain more data located in concentrated areas.

In yet other examples, the control circuit may be configured to append the at least one boundary condition to the reduced distribution to maintain this data. This data may be useful for the purpose of determining the limit of the data space for a given timeframe. The approaches may also include a plurality of groups of sensor data values by which reduced distributions are obtained. In other words, sensor data from multiple sensors corresponding to a single or multiple assets may be decimated or reduced in these approaches.

In still other examples, approaches are provided where a group of historical data are obtained which include plurality of vectors which in turn include a group of sensor data values. At least one boundary condition is defined for the historical data, and the boundary condition is preserved. Magnitudes of the plurality of vectors are computed, and a reduced distribution of the group of historical data is obtained using a statistical sampling.

### BRIEF DESCRIPTION OF THE DRAWINGS

For a more complete understanding of the disclosure, reference should be made to the following detailed description and accompanying drawings wherein:

FIG. 1 comprises a block diagram illustrating an exemplary system for decimation of historical dataset according to various embodiments of the present invention;

FIG. 2 comprises an operational flow chart illustrating an approach for decimation of historical dataset according to various embodiments of the present invention;

FIG. 3 comprises an operational flow chart illustrating an example down-sampling approach as described in FIG. 2; and

FIG. 4 comprises an exemplary illustration of a down-sampling approach as described in FIG. 3.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

Approaches are provided that overcome the time consuming and expensive process of running empirical models using historical data sets. In one aspect, upon reducing the size of the historical data, the down sampled data may be used in conjunction with systems and/or approaches that preemptively detect anomalies within industrial assets and their corresponding systems. A vector, or a data snap shot in time across a single or multiple sensors, may store a data value or values which are in turn stored or grouped in data sets of varying size. Vectors are then grouped with other vectors to form historical data sets.

By computing the magnitude of the sensor data, a scalar quantity defining the vector is obtained. It is understood that any quantity or feature set may alternatively be used in place of the calculated magnitude.

In some approaches, a user may select a particular asset in a software program and transmit a command to clean or decimate the historical data associated with the asset. A user editing session may then be created on behalf of the user for use in the data clean-up process, which may be used to prevent conflicts with the software program running on the computing device. For each asset selected, a target number of vectors is determined. The asset is then “checked out” by the user editing session, and historical data for the asset is loaded. In some approaches, disjoint data prior to the earliest vector, referenced by subsequent empirical models, is trimmed. If no disjoint data exists, data older than a specified time (e.g., six months prior to the earliest referenced vector) is trimmed. By “disjoint data” and as used herein, it is meant any adjacent vectors or groups of vectors separated by a timespan that is significantly larger than the poll rate at which nearby clusters of vectors are sampled.

In the event that the number of remaining vectors is less than or equal to the target vector size, cleanup is complete and no rebuilding of the data set is necessary. If the number of remaining vectors is not less than the target vector size, filters are executed using predetermined filter parameters, and filtered vectors are excluded. Minimum and maximum vectors are then identified, either across the entirety of the remaining dataset or on its subsets, as determined by subsequent modeling processes. These vectors are marked to be retained and are exempt from subsequent processing steps.

The remaining data is then down sampled while excluding vectors already identified to be the minimum and maximum. Down sampling the data results in the number of remaining vectors equaling the target vector count. Vectors that are not selected by down sampling are then removed, and the minimum and maximum vectors may then be appended. Finally, the empirical models are rebuilt from the new dataset if required.

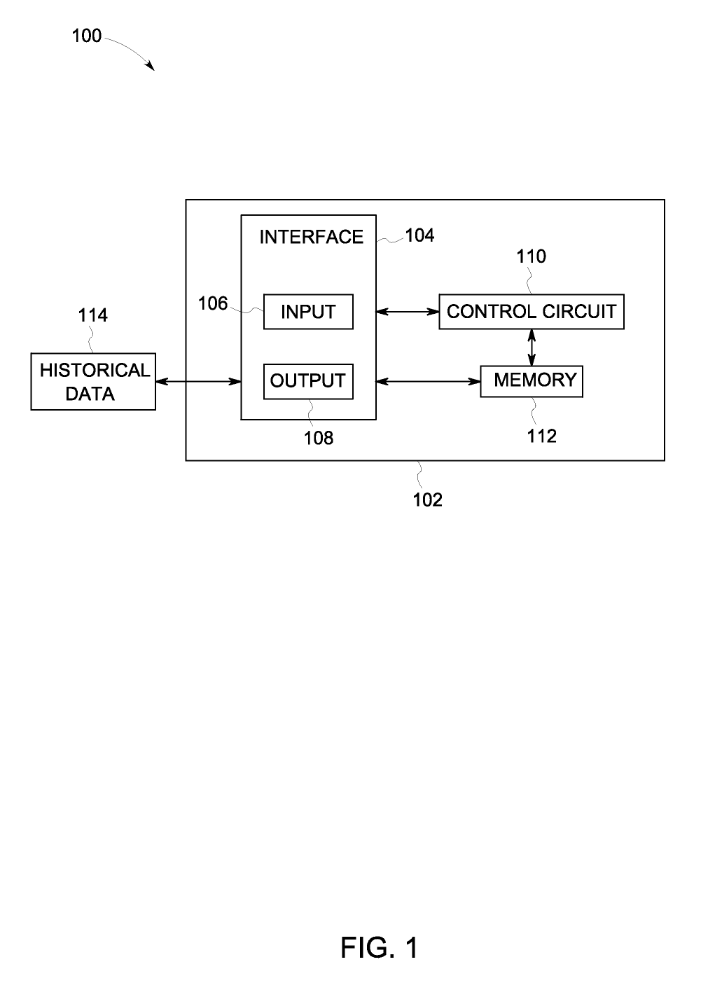

Referring now to FIG. 1, one example of a system 100 for decimation of historical dataset is described. The system 100 includes an apparatus 102 which includes an interface 104 having an input 106 and an output 108, a control circuit 110, a memory 112, and historical data 114. The historical data 114 may be stored in the memory 112 and may alternatively be a standalone component. The apparatus 102 may be stored on a cloud-based network.

The apparatus 102 is any combination of hardware devices and/or software selectively chosen to generate, display, and/or transmit communications. The interface 104 is a computer based program and/or hardware configured to accept a command at the input 106 and transmit the generated communication at the output 108. Thus, one function of the interface 104 is to allow the apparatus 102 to communicate with and receive the historical data 114, the control circuit 110, and the memory 112. The apparatus 102 may be deployed on the cloud or any other networking construct. By “cloud” and as used herein, it is meant any combination of networking components such as servers, switches, constructs, and/or other components used to provide network access to a number of systems. In some forms, the cloud may include multiple networks or apparatuses which serve different purposes in the system 100.

The memory 112 may be stored on the apparatus 102 or any known system. In some examples, a portion of the memory stores the original or decimated historical data 114 and is stored directly on the apparatus 102. Alternatively, the memory 112 may store the historical data 114 on a cloud-based device separate from the apparatus 102. It is understood that in some forms, only a portion of the memory 112 stores the historical data 114, and the remainder is stored at a remote location (e.g., on the cloud or another remote networking device). Further, it is understood that the memory 112 may store any number of down sampling blueprint (not pictured) used to downs sample the historical data 114. The down sampling blueprint may be a data structure that includes any number of data elements used to down sample the historical data 114.

In some forms, the apparatus 102 may be located on a local computing device which is any combination of hardware and/or software elements configured to execute a task. In some forms, the local computing device may be a remote networking control device accessible by the apparatus 102 and any number of additional computing devices. In some forms, the local computing device may communicate with cloud-based apparatuses and/or remote servers which networked to provide a centralized data storage access to services or resources.

The historical data 114 may be any combination of vectors and/or vector data relating to industrial assets. For example, the historical data 114 may be data obtained from any number of sensors configured to sense and obtain values relating to the operation of the asset. The historical data 114 may include vector data provided over a period of time, or “time-series data”. By “time series data” and as used herein, it is meant data relating to the operation of the industrial system being obtained, presented, and/or organized in a sequential manner according to time. Thus, time series data allows for a user or system to measure a change in a characteristic of the industrial system over a provided period of time. This historical data 114 may be derived from pumps, turbines, diesel engines, jet engines, or other industrial systems having any number of sensors, gauges, and other components for measuring time series data. Other examples are possible.

The data structures utilized herein may utilize any type of programming construct or combination of constructs such as linked lists, tables, pointers, and arrays, to mention a few examples. Other examples are possible.

The control circuit 110 is a combination of hardware devices and/or software selectively chosen to monitor settings of the desired system and down sample the historical data 114. The control circuit 110 may be physically coupled to the interface 104 through a data connection (e.g., an Ethernet connection), or it may communicate with the interface 104 through any number of wireless communications protocols.

It will be appreciated that the various components described herein may be implemented using a general purpose processing device executing computer instructions stored in memory.

In operation, the control circuit 110 is configured to obtain a group of historical data 114 comprising a plurality of vectors via the input 106. The plurality of vectors may include a group of sensor data values. The control circuit 110 then is configured to determine at least one boundary condition for the group of historical data 114.

The control circuit 110 further is configured to preserve the at least one boundary condition and down sample the data. In one aspect, the circuit 110 computes a plurality of magnitudes of the plurality of vectors and use a statistical sampling of the plurality of magnitudes to obtain a reduced distribution of the group of historical data to transmit via the output 108. The reduced distribution may be stored on the memory 112.

In some forms, the control circuit 110 is configured to arrange the vectors into an arranged distribution. In one example, the arranged distribution may be determined based on the magnitude of vectors. Other examples are possible. The statistical sampling of the arranged distribution may be used to obtain the reduced distribution of the group of historical data. In other words, the statistical sample may be a selectable integer value, whereby every “nth” sample will be selected and retained, while other samples will be removed or decimated. It is understood that the frequency of obtaining samples may be any value less than the total number of vectors present.

In some examples where the historical data 114 has an unusual distribution, the control circuit 110 is configured to use a statistical sampling based on a number of median values to obtain a subset of the arranged distribution. By capturing multiple statistical median values of the data set, the samples will be representative of the unusual distribution.

The control circuit 110 may further append at least one of the boundary conditions to the reduced distribution of the group of historical data 114. It is understood that the historical data 114 may include any number of groups of sensor data values, thus the control circuit 110 may process and down samples these groups simultaneously or in succession of each other, as desired.

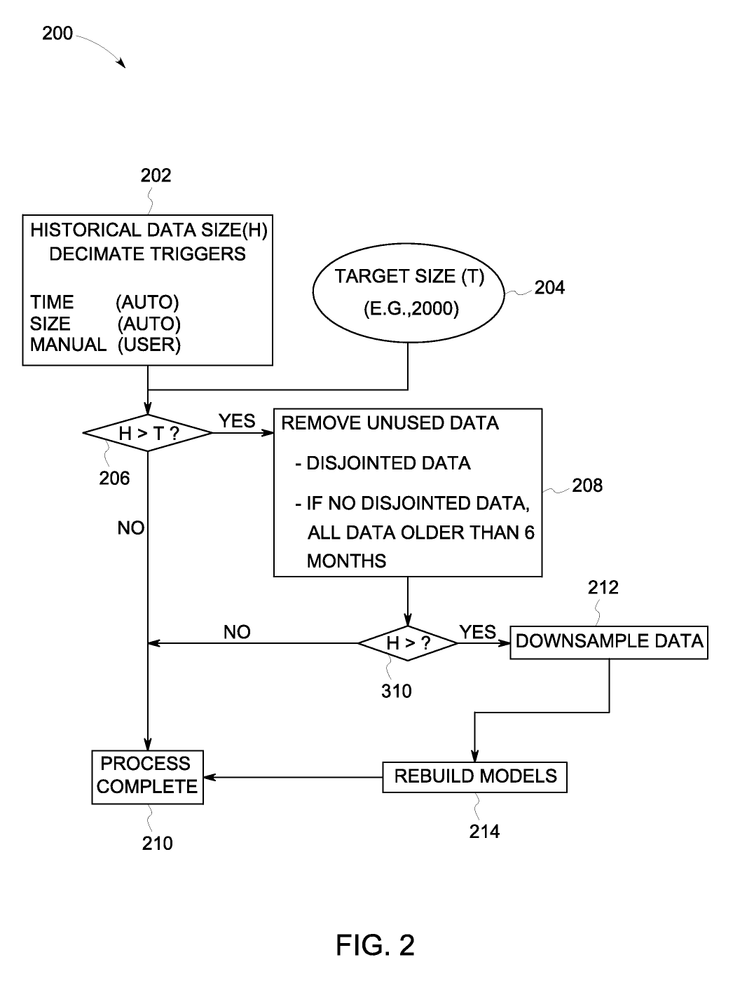

Turning to FIG. 2, an approach 200 for the decimation of historical dataset is provided. First, at step 202, historical data having a size of H is obtained. The group of historical data includes a plurality of vectors which in turn include a group of sensor data values. The approach 200 may be triggered manually by a user or automatically using set times, durations, and/or sizes of historical data. At step 204, a target size (T) is set. In some aspects, this may be set by a user. At step 206, it is determined whether the historical data size is larger than the target size. If the historical data set size is not larger than the target data size, the approach proceeds to step 210 where the process is completed.

If the historical data set size is larger than the target data size, the approach proceeds to step 208, where unused data is removed. This may include disjointed data that is older than and prior to the oldest vector referenced by subsequent modeling processes. If there is no disjoint data found within a designated period (e.g., six months), all the data older than the designated time period is removed. At step 210, it is again determined whether the historical data set size is larger than the target data set size. If the historical data set size is not larger than the target data set size, the approach proceeds to step 210 where the process is completed.

If the historical data set size is larger than the target data set size, at step 212, the data set is down-sampled within the model definition ranges. In some aspects, a reduced distribution of the group of historical data is obtained. In other approaches, at least one boundary condition may be determined and appended to the reduced distribution to maintain this data for use by the empirical models. This data may be useful for the purpose of determining the limit of the data space for given timeframes.

The approaches may also include obtaining reduced distributions for a plurality of groups of sensor data values. In other words, sensor data from multiple sensors corresponding to a single or multiple assets may be decimated or reduced in these approaches.

At step 214, the empirical model is rebuilt. This may include preserving the data range of the reference data of each model, removing the filtered data therefrom, and building the model using the user-defined approach. At step 210, the process is completed.

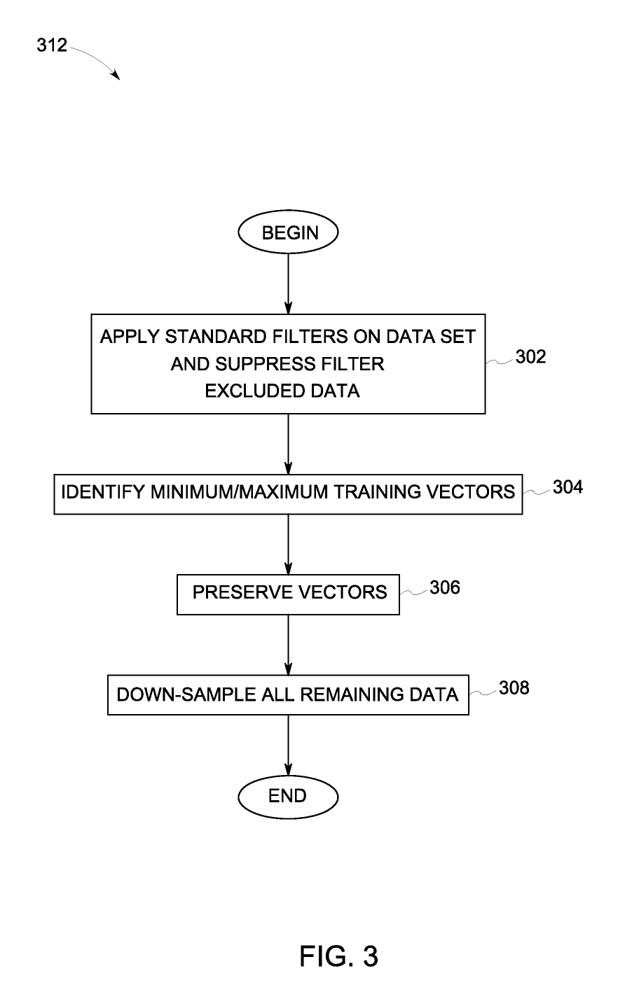

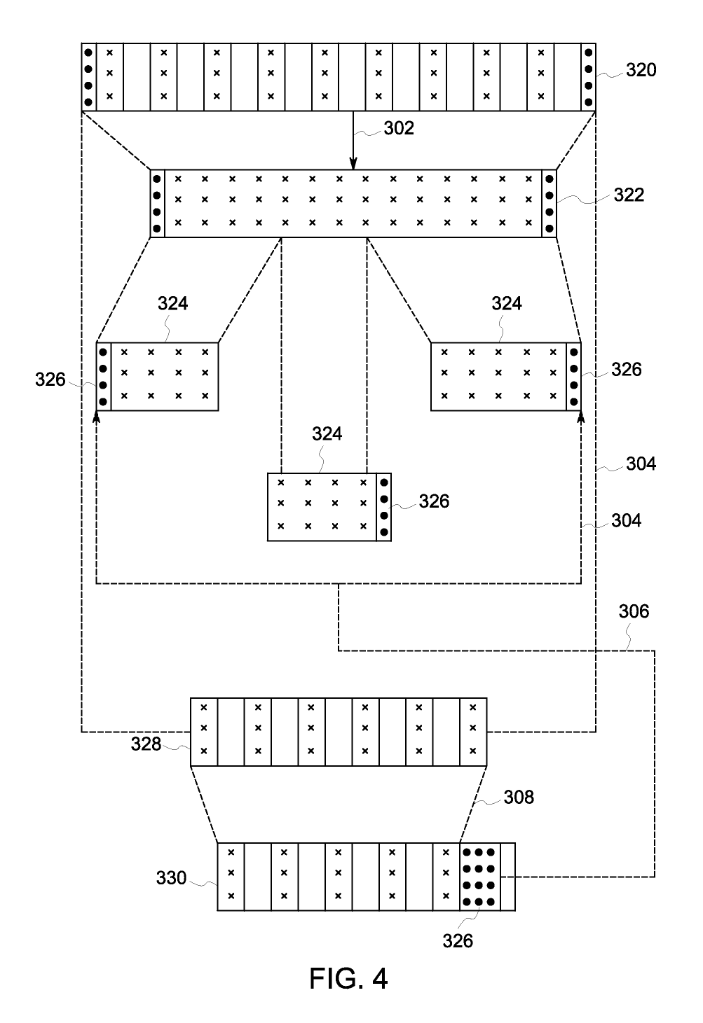

Turning now to FIG. 3 and FIG. 4, an exemplary down-sampling approach (step 212 as described in FIG. 2) is illustrated in greater detail. First, at step 302, standard filters are applied on the data set 320 and used to suppress the excluded data to produce data set 322. These filters may remove abnormal or greatly out-of-expected range data, for example. At step 304, the filter is used to suppress excluded data.

At step 304, min/max training vectors 326(e.g., boundary conditions) are identified for each data range 324, and at step 306 these vectors are preserved. In one example, each data range 324 represents a different mode of operation.

At step 308, the remaining data 328 (the data set 322 without boundary conditions) is down-sampled to produce down sampled data set 330. In some approaches, the preserved vectors 326 may then be appended to the down-sampled data set 330. The down sampled set 330 may be used to reconstruct one of more models.

It will be appreciated by those skilled in the art that modifications to the foregoing embodiments may be made in various aspects. Other variations clearly would also work, and are within the scope and spirit of the invention. The present invention is set forth with particularity in the appended claims. It is deemed that the spirit and scope of that invention encompasses such modifications and alterations to the embodiments herein as would be apparent to one of ordinary skill in the art and familiar with the teachings of the present application.

What is claimed is:

1. A method, comprising:
obtaining a group of historical data representing a model comprising a plurality of vectors, the plurality of vectors comprising a group of sensor data values;
applying a filter to the group of historical data;
determining at least one boundary condition for the group of historical data;
preserving the at least one boundary condition;
down-sampling the filtered group of historical data without down-sampling the at least one boundary condition; and
rebuilding the model using the down-sampled historical data.

2. The method of claim 2, wherein the step of down-sampling the filtered group of historical data comprises computing a plurality of magnitudes of the plurality of vectors and using a statistical sampling of the plurality of magnitudes to obtain a reduced distribution of the group of historical data.

3. The method of claim 1, wherein the down sampling comprises arranging the plurality of vectors in an arranged distribution.

4. The method of claim 3, wherein the arranged distribution is used to obtain down-sampled distribution of the group of historical data.

5. The method of claim 3, wherein the arranged distribution comprises a plurality of median values to obtain a statistical median of a subset of the arranged distribution.

6. The method of claim 5, further comprising the step of computing a plurality of subsequent statistical medians of the subset of the arranged distribution.

7. The method of claim 1, further comprising the step of appending the at least one boundary condition to the reduced distribution of the group of historical data.

8. The method of claim 1, further comprising a plurality of groups of sensor data values, wherein a plurality of reduced distributions are obtained.

9. An apparatus, comprising:
an interface having an input and an output; and
a control circuit coupled to the interface;
wherein the control circuit is configured to obtain, via the input, a group of historical data representing a model comprising a plurality of vectors, the plurality of vectors comprising a group of sensor data values and apply a filter to the group of historical data, the control circuit further configured to determine at least one boundary condition for the group of historical data, the control circuit further being configured to preserve the at least one boundary condition, down-sample the filtered group of historical data without down-sampling the at least one boundary condition, and rebuild the model using the down-sampled historical data.

10. The apparatus of claim 9, wherein down-sampling the filtered group of historical data comprises computing a plurality of magnitudes of the plurality of vectors and using a statistical sampling of the plurality of magnitudes to obtain a reduced distribution of the group of historical data to transmit via the output.

11. The apparatus of claim 9, wherein the control circuit is configured to arrange the plurality of vectors in an arranged distribution.

12. The apparatus of claim 11, wherein the statistical sampling of the arranged distribution is used to obtain the down-sampled distribution of the group of historical data.

13. The apparatus of claim 11, wherein down-sampling the filtered group comprises determining a plurality of median values to obtain a statistical median of a subset of the arranged distribution.

14. The apparatus of claim 13, wherein the control circuit is further configured to compute a plurality of subsequent statistical medians of a subset of the arranged distribution.

15. The apparatus of claim 9, wherein the control circuit is further configured to append the at least one boundary condition to the reduced distribution of the group of historical data.

16. The apparatus of claim 9, further comprising a plurality of groups of sensor data values, wherein a plurality of reduced distributions are obtained.
